(19) United States
(12) Patent Application Publication
(10) Pub. No.: US 2024/0096033 A1
(43) Pub. Date: Mar. 21, 2024

(54) TECHNOLOGY FOR CREATING, REPLICATING AND/OR CONTROLLING AVATARS IN EXTENDED REALITY

(71) Applicant: Meta Platforms Technologies, LLC, Menlo Park, CA (US)

(72) Inventors: Sean McCracken; Saransh Solanki, Seattle, WA (US)

(21) Appl. No.: 17/963,951

(22) Filed: Oct. 11, 2022

Related U.S. Application Data
(60) Provisional application No. 63/254,520, filed on Oct. 11, 2021.

(51) Int. Cl. G06T 19/00; G06F 3/01

(52) U.S. Cl. CPC G06T 19/006; G06F 3/011

(57) ABSTRACT

A technology for creating, replicating and/or controlling avatars in an extended-reality (ER) environment can include methods, extended-reality-compatible devices, and/or systems configured to generate, e.g., via an ER-compatible device, a copy of a representation of a user, e.g., a primary avatar, and/or an object in an ER environment, to initiate a recording of the graphical representation of the user or object according to a schema; to produce a copy of the recording of the graphical representation of the user as a new graphical representation of the user, e.g., a new avatar, in the ER environment; and to control the new graphical representation of the user at a first location in the ER environment. In examples, the technology enables moving the graphical representation of the user around the ER environment while the new graphical representation of the user performs motion and/or produces sound from the copy of the recording.

### CROSS-REFERENCE TO RELATED APPLICATIONS

This application is a non-provisional of, and claims priority to and the benefit of, U.S. Provisional Patent Application Ser. No. 63/254,520, filed Oct. 11, 2021, and entitled “Technology for Creating, Replicating and/or Controlling Avatars in Extended Reality,” the entirety of which is incorporated herein by reference.

### BACKGROUND

Bodystorming is a design process in which design team members interact with physical props to show an interaction or a story without building anything digitally—it equates to the physical version of brainstorming. Bodystorming requires more than one person to enact, roleplay, and record a session. Another time-consuming and resource intensive process that typically requires multiple co-located designers is rigging. Rigging is the process of animating a static 3-dimensional avatar by defining the character's limbs and moving parts and adding motion in a joint-by-joint process to create avatar actions for video games, prototyping, and extended reality demonstrations, which requires a lot of technical expertise. Conventionally, both bodystorming and rigging have required a co-located team with a separate user to perform predetermined actions for each avatar plus at least one user to capture/film the actions and interaction making these processes time consuming and costly.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example environment in which techniques for creating, replicating, and/or controlling avatars in an extended-reality environment can be implemented.

FIG. 2 is a block diagram depicting an example computing device configured to participate in creating, replicating, and/or controlling avatars and objects in an extended-reality environment.

FIG. 3(A) illustrates example uses of the technology described herein.

FIG. 3(B) illustrates example uses of the technology described herein.

FIG. 3(C) illustrates example uses of the technology described herein.

FIG. 3(D) illustrates example uses of the technology described herein.

FIG. 4 illustrates an example of the technology described herein.

FIG. 5(A) illustrates an example of the technology described herein to control multiple avatars in an extended reality environment.

FIG. 5(B) illustrates an example of the technology described herein to control multiple avatars in an extended reality environment.

FIG. 5(C) illustrates an example of the technology described herein to control multiple avatars in an extended reality environment.

FIG. 5(D) illustrates an example of the technology described herein to control multiple avatars in an extended reality environment.

FIG. 5(E) illustrates an example of the technology described herein to control multiple avatars in an extended reality environment.

FIG. 5(F) illustrates an example of the technology described herein to control multiple avatars in an extended reality environment.

FIG. 5(G) illustrates an example of the technology described herein to control multiple avatars in an extended reality environment.

FIG. 5(H) illustrates an example of the technology described herein to control multiple avatars in an extended reality environment.

FIG. 5(I) illustrates an example of the technology described herein to control multiple avatars in an extended reality environment.

FIG. 5(J) illustrates an example of the technology described herein to control multiple avatars in an extended reality environment.

FIG. 5(K) illustrates an example of the technology described herein to control multiple avatars in an extended reality environment.

FIG. 5(L) illustrates an example of the technology described herein to control multiple avatars in an extended reality environment.

FIG. 6 is a flowchart illustrating an example process employing the technology described herein.

### DESCRIPTION

This application is directed to a technology that can enable an individual to create, replicate, and/or control one or more computer-generated visual representations of a user (e.g., replicas, avatars, clones, etc.) in an extended-reality (ER) environment. The technology described herein can enable an individual using an extended-reality-compatible device to create and/or control any number of computer-generated visual representations, aka “replicas,” of themselves, (e.g., avatars, clones, etc.). The replicas can supply full context asynchronous communication by replicating one or more of speech, body language, facial expression, etc., can enable automation of the formerly time and resource intensive rigging process, and/or can perform quicker and much more cost effective bodystorming, etc.

The technology and techniques described herein can enable an individual using an extended-reality-compatible device to effectively do a virtual version of bodystorming on their own—without the minimum of two more people that was previously required. In contrast to the conventional process of a separate person performing predetermined actions for each avatar and one or more camera operators, an individual can generate multiple clones of avatars representing the individual user performing respective actions and one or more cloned cameras. The techniques described herein can enable an individual using an extended-reality-compatible device to effectively do a virtual version of rigging quickly based on their own movements. In contrast to the conventional process of rigging, in which an animator starts with a static 3-dimensional (3D) avatar and defines the character's limbs and moving parts, then adds motion in a joint-by-joint process to create avatar actions for video games, prototyping, and extended reality demonstrations, an individual can generate multiple clones of avatars representing the individual user performing the desired actions without requiring the technical expertise previously required to specifically define individual limbs and joints in order to effect the animation.

Thus, the technology can greatly reduce the amount of time and resources required for prototyping, animation, game development, etc. Various aspects of the technology are described further below in text and via accompanying images and drawings. The images and drawings are merely examples and should not be construed to limit the scope of the description or claims. For example, while examples are illustrated in the context of a user interface for an ER-compatible device, the techniques can be implemented in 2D and/or 3D, and using any computing device. The user interface can be adapted to the size, shape, and configuration of the particular computing device.

This application describes techniques and features for creating, replicating, and/or controlling avatars, which can interact with other avatars and/or objects in an ER environment. As used herein, the terms “virtual environment,” “extended-reality environment” or “ER environment” refer to a simulated environment in which users can fully or partially immerse themselves. For example, an ER environment can comprise virtual reality, augmented reality, mixed reality, etc. An ER environment can include virtual representations of users (avatars), virtual objects and/or virtual representations of physical items with which a user, or an avatar of a user, can interact and/or manipulate, e.g., by picking them up, dropping them, throwing them, otherwise moving them, taking them from another avatar, receiving them from another avatar, etc. In many cases, a user participates in an ER environment using a computing device, such as a dedicated ER device. As used herein, the terms “extended-reality device” or “ER device” refer to a computing device having ER capabilities and/or features. In particular, an ER device can refer to a computing device that can display an extended-reality user interface—in some examples, an audio and/or a graphical user interface. An ER device can further display one or more visual elements within the extended-reality graphical user interface and receive user input that targets those visual elements. For example, an ER device can include, but is not limited to, a virtual-reality (VR) device, an augmented-reality (AR) device, and/or a mixed-reality (MR) device. In particular, an ER device can include any device capable of presenting a full and/or partial extended-reality environment. Nonlimiting examples of extended-reality devices can be found throughout this application.

In various examples, an extended-reality system can provide a representation of ER content (e.g., VR content, AR content, MR content, etc.) to a computing device, such as an ER-compatible computing device. In some examples, the ER system can include and/or be implemented by an ER-compatible computing device. The techniques described herein involve making clones, copies, or instances of one or more avatars, e.g., of the body of a user of an ER-compatible device and can include representing movement and/or associated sounds made by the user. This provides a new framework for an individual being able to create, replicate, and/or control avatars, which can interact with other avatars and/or objects in an ER environment. The techniques described herein can also involve making clones, copies, or instances of one or more objects, e.g., hands of the user of an ER-compatible device's and/or other body parts. The techniques may additionally or alternatively involve making clones, copies, or instances of cameras to enable users to establish multiple different points of view or perspectives within an extended reality environment. The avatar(s) can interact with each other, and/or with clones, copies, or instances of object(s) and/or camera(s) in the ER environment and in some examples, make clones, copies, or instances at another location, and/or make clones, copies, or instances that can be virtually left at different locations, like by a bookshelf, a white board, a desk, a game space, a social space, etc. so that the user can simply switch focus to interact with that location without needing to physically move to that location. This provides a new framework for being able to create, replicate, and/or control objects and items in ER.

In some examples, the ER content includes computer-generated content configured to be presented in association with an ER environment such as at least one of a VR environment, an AR environment, and/or an MR environment. The technology provides an enhanced experience in ER for creating cloned avatars that can provide enhanced-asynchronous communication, and/or interact with user(s) in an ER environment, with each other and/or with virtual objects and items near and far, depending on the context.

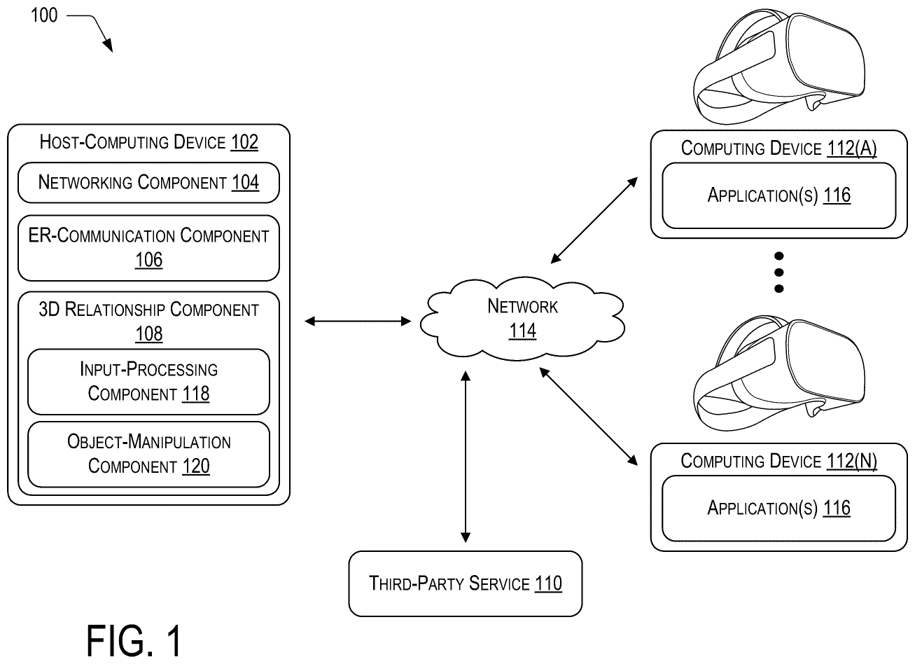

FIG. 1 is a schematic view of an example system 100 usable to implement example techniques for creating, replicating and/or controlling avatars in an extended reality environment based on input via the system 100. The example system 100 includes a host-computing device 102 that includes a networking component 104, an ER-communication component 106, and a three-dimensional (3D) relationship component 108. The system 100 can include a third-party service 110, and computing devices, e.g., ER-compatible computing devices 112(A), . . . 112(N) (collectively “computing devices 112”). In this example, A and N are non-zero integers greater than or equal to 1.

The host-computing device 102, the third-party service 110, and the computing device(s) 112 are communicatively coupled to one another via a network 114. The network 114 can be representative of any one or more communication networks, including fiber optic, cable, public switched telephone, cellular, satellite, wide area, local area, personal area, and/or any other wired and/or wireless networks. Although the system 100 of FIG. 1 is depicted as having a particular number of components, the system 100 can have any number of additional or alternative components (e.g., any number of host computing devices, client devices, third-party services, and/or other components in communication with one another via one or more networks). Any or all of the components (e.g., the host computing devices, the third-party services, and/or the computing devices 112) can include one or more processors and memory storing computer- or processor-executable instructions to implement the functionality discussed herein attributable to the various computing devices.

In some examples, the system 100 can facilitate communication between users via an extended reality environment (e.g., virtual reality, mixed reality, augmented reality, or other computer-generated environment). For example, the computing devices 112 can include one or more display devices (e.g., display screens, projectors, lenses, head-up displays, etc.) capable of providing an extended reality display. By way of example and not limitation, computing devices 112, including ER-compatible devices, can include wearable computing devices (e.g., headsets, glasses, helmets, or other head-mounted displays, suits, gloves, watches, etc.), handheld computing devices (e.g., tablets, phones, handheld gaming devices, etc.), portable computing devices (e.g., laptops), or stationary computing devices (e.g., desktop computers, televisions, set top boxes, vehicle display, head-up display, etc.). The computing devices 112 can be implemented as standalone computing devices comprising substantially all functionality in a single device, or can be coupled via wired or wireless connection to one or more other computing devices (e.g., PCs, servers, gateway devices, coprocessors, etc.), peripheral devices, and/or input/output devices.

The computing devices 112 can store and/or execute one or more applications 116, such as operating systems, a web browser, or other native or third-party applications (e.g., social media applications, messaging applications, email applications, productivity applications, games, etc.). The applications 116 can execute locally at the computing devices 112 and/or can communicate with one or more other applications, services, or devices over the network 114. For instance, the computing devices 112 can execute one or more of the applications 116 to interface with the networking component 104, the extended reality communication component 106, and/or the 3D relationship component 108 of the host computing device 102. Additionally or alternatively, the computing devices 112 can execute one or more of the applications 116 to interface with functionality of the third-party service 110.

The host computing device 102 can generate, store, receive, and/or transmit data, such as networking data, communications data, extended reality data, and/or application data. For example, the host computing device 102 can receive user input from and/or output data to one or more of the computing devices 112. As shown in FIG. 1, the host computing device 102 includes a networking component 104. In some examples, the networking component 104 can provide a digital platform that includes functionality through which users of the networking component 104 can connect to and/or interact with one another. For example, the networking component 104 can register a user (e.g., a user of one of the computing devices 112) to create an account for the user. The networking component 104 can, with input from a user, create and store a user profile associated with the user. The user profile can include demographic information, communication channel information, and information on personal interests of the user. The user profile information can additionally or alternatively include, for example, biographic information, demographic information, behavioral information, the social information, or other types of descriptive information, such as work experience, educational history, hobbies or preferences, interests, affinities, or location. Interest information can include interests related to one or more categories, which can be general or specific. As an example, if a user “likes” an article about a brand of shoes, the category can be the brand.

The networking component 104 can further provide features through which the user can connect to and/or interact with other users. For example, the networking component 104 can provide messaging features and/or chat features through which a user can communicate with one or more other users. The networking component 104 can also generate and provide groups and communities through which the user can associate with other users.

Authorization services can be used to provide and enforce one or more privacy settings of the users of the networking component 104. A privacy setting of a user determines how particular information associated with a user can be shared. The authorization services can allow users to opt in to or opt out of having their actions logged by the networking component 104 or shared with other applications (e.g., extended reality communication component 106, 3D relationship component 108, applications 116) or devices (e.g., the third-party service 110), such as, for example, by setting appropriate privacy settings.

In some examples, networking component 104 comprises a social networking service (such as but not limited to Facebook™, Instagram™, Snapchat™, LinkedIn™, etc.). Alternatively or additionally, the networking component 104 can comprise another type of system, including but not limited to an e-mail system, search engine system, e-commerce system, gaming system, banking system, payment system, or any number of other system types with which users have accounts. In examples in which the networking component 104 comprises a social networking system, the networking component 104 can include a social graph system for representing and analyzing a plurality of users and concepts. A node storage of the social graph system can store node information comprising nodes for users, nodes for concepts, and nodes for items. An edge storage of the social graph system can store edge information comprising relationships between nodes and/or actions occurring within the social networking system.

The host computing device 102 in this example includes the extended reality communication component 106. In some examples, the extended reality communication component 106 utilizes the host computing device 102 to enable users to communicate with one another in an extended reality communication session. For example, the extended reality communication component 106 can utilize the host computing device to receive user input corresponding to a particular co-user and send an invitation to join an extended reality communication session to an extended reality device corresponding to the co-user.

For example, the extended reality communication component 106, via host computing device 102, generates an extended reality lobby user interface element, e.g., a graphical user interface element for display on an extended reality device (e.g., one of the computing devices 112) associated with a user of a networking system. The extended reality communication component 106 further, via host computing device 102, determines a connection (e.g., on the social graph) between the user and a co-user. Based on the connection, the extended reality communication component 106 provides a computer-generated visual representation (e.g., avatar) of the co-user for display within the extended reality lobby visible via the extended reality lobby user interface element, e.g., a graphical user interface element displayed on the extended reality device associated with the user. Via the host computing device 102, the extended reality communication component 106 receives user input targeting the computer-generated visual representation of the co-user and generates and sends an invitation to join an extended reality communication session for display on an extended reality device associated with the co-user.

The host computing device 102 in this example includes the 3D relationship component 108. The 3D relationship component 108 in the illustrated example includes an input-processing component 118 and an item-manipulation component. In some examples, the 3D relationship component 108 receives an input from one of the computing devices 112, and generates a 3D visual representation of a relationship in an extended reality environment based at least in part on the input by leveraging various functionality described below of the input-processing component 118 and the item-manipulation component 120. Examples herein may refer to an input received by the 3D relationship component 108 and/or the input-processing component 118 generally as an input device that can receive input as touch input, button press input, speech input, and other types of inputs are supported as well, including as gaze tracking or gaze input, head position, gesture inputs, controller inputs, and other forms of input as further mentioned herein. In some instances, different and/or multiple inputs can be interpreted by the 3D relationship component in tandem with one another to discern meaning of the multiple inputs, such as by associating a path of a gaze of a user of the computing device 112(A), a path of a pose (e.g., as indicated by pointing with or without a handheld controller), and/or a speech input. Other combinations of different and/or multiple inputs are also considered.

For example, the input-processing component 118 can receive an input from a computing device 112(A) via the network 114. For instance, the computing device 112(A) can include one or more cameras and/or microphones that capture images and/or sound in an environment surrounding the computing device 112(A). The computing device 112(A) can transmit a signal corresponding to the images and/or sound captured by the camera(s) and/or microphone(s) to the input-processing component 118. In examples, the input-processing component 118 can determine that the image and/or sound represented by the signal includes gestures and/or speech. Gesture(s) detected from such a signal is referred to herein as “gesture input,” and speech detected from such a signal is referred to herein as a “speech input.”

In some instances, the input-processing component 118 determines a semantic meaning from input. To determine the semantic meaning, the input-processing component 118 can leverage one or more machine-learned models. For instance, the input-processing component 118 can input the input (and/or a transcription thereof) into a deep neural network, where the deep neural network is trained to determine a semantic meaning of the input. In some cases, the deep neural network can also determine a context of multiple inputs, such as during a conversation between users of multiple of the computing devices 112 during a shared ER session.

In some scenarios, the input-processing component 118 can “learn” the semantic meaning of new inputs, e.g., gestures, words, or phrases, by tracking actions taken by user(s) of the computing device(s) 112 in an ER environment over time. In an illustrative example, a user of the computing device 112(A) can provide a speech input that includes “bring me the book Gulliver's Travels from the library,” and a copy of a graphical representation of an object associated with a user of the computing device 112(N) can select the book “Gulliver's Travels” from the library and move the book to the user of the computing device 112(A). If input-processing component 118 does not have a previous semantic meaning for “the book Gulliver's Travels,” (and/or has a different semantic meaning for “the book Gulliver's Travels” than the item that was passed), the input-processing component 118 can assign the term “the book Gulliver's Travels” to the item that was passed. When the term “the book Gulliver's Travels” is used in future ER sessions, the input-processing component 118 can rely on this semantic meaning associated with the item to search for the same or similar items that are being referenced in the ER environment.

A similar technique can be employed by the input-processing system 118 for action terms (e.g., verbs) provided by a user of any of the computing devices 112 and previously unknown to the input-processing component 118 as well. For example, the user of the computing device 112(A) can provide an input to “open the book,” and the copy of a graphical representation of the object can perform the action of opening the book. As another example, the user of the computing device 112(A) can provide an input to “bring me the book,” and the copy of a graphical representation of the object can perform the action such as by moving the moving the book from the library to the user in the extended reality environment. Other examples are also considered of functionality employed by the input-processing component 118 to determine a semantic meaning of the input.

In some examples, the input-processing component 118 determines whether the input corresponds to manipulating one or more objects in an ER environment, whether the input corresponds to creation or modification of a mind map in the ER environment, and/or navigation or modification of a timeline of an ER session, among other examples. For example, the input-processing component 118 can determine that an input corresponds to modifying a mind map based on a determination that the computing device 112(A) is utilizing an application 116 for brainstorming. In another example, input-processing component 118 can determine that an input corresponds to adding another copy of a graphical representation of an object and/or a copy of a graphical representation of another object and/or an item to an ER environment based on a determination that the computing device 112(A) is utilizing an application 116 that for which one or more additional clones, copies, or instances and/or items would be desirable in the extended reality environment. In yet another example, input-processing component 118 can determine that an input corresponds to adding another copy of a graphical representation of a user (avatar) to an ER environment based on a determination that the computing device 112(A) is utilizing an application 116 for creating, replicating, and/or controlling avatar(s) in the extended reality environment.

Based on the semantic meaning, and in some cases a determination of the application 116 being executed by the computing device 112(A) when the input was received, the input-processing component 118 can determine terms from the input that represent a relationship. For instance, in the case of the computing device 112(A) executing a brainstorming application, the input-processing component 118 can determine relationships between concepts to be included in a mind map. To illustrate, the input-processing component 118 can receive a speech input that includes “Let's talk about the size and shape of the new widget.” In response, the input-processing component 118 can determine that “widget” is a concept of a mind map during a brainstorming session, and “size” and “shape” are sub-concepts related to the “widget” concept.

In examples, the input-processing component 118 can provide the terms to the item-manipulation component 120 to automatically generate a 3D visual representation of the relationship between the terms. For instance, the item-manipulation component 120 can receive an indication of an object in an extended reality environment as a first term, and an action to manipulate the object as a second term. Based on the first term and the second term, the item-manipulation component 120 can generate the representation of the action to be performed relative to the item in three dimensions in the extended reality environment. In an illustrative example, a speech input can include “Put a hat on the avatar,” where the terms provided by the input-processing component 118 to the object manipulation component 120 are “put,” “hat,” and “avatar.” The item manipulation component 120 can generate a 3D representation of the terms by selecting a VR hat object from an object library (not pictured) of the host computing device 102, and causing the VR hat object to appear on an avatar in an ER environment being presented to a user via the computing device 112(A).

The 3D relationship component 108 (and the components associated therewith) can be configured to visually represent relationships based on speech inputs from a single user or multiple users. For example, the input-processing component 118 can receive a first input from a first user of the computing device 112(A) in an ER environment. Based on this first input and terms extracted by the input-processing component 118, the item-manipulation component 120 can cause a first object to perform an action associated with the item and present a view of the action to the first user via the computing device 112(A) and a second user of the computing device 112(N) who is also present in the ER environment, although the second user can be in a different physical location than the first user. The input-processing component 118 can then receive a second input from the second user to interact with the item. The input-processing component 118 can determine a second semantic meaning of the second input using the techniques described herein. The input-processing component 118 can provide the terms from the semantic meaning to the item-manipulation component 120 can cause a second object to perform an action associated with the item and present a view of the action to the first user via the computing device 112(A) and a second user of the computing device 112(N). In this way, multiple users can leverage the capabilities of the 3D relationship component to collaboratively create visual relationships in ER environments.

While the 3D relationship component 108, the input-processing component 118 and the item-manipulation component are shown in this example as separate components of the host computing device 102, in other examples, any of these components can be a sub-component or feature of the ER-communication component 106, the computing devices 112, the third-party service 110, or another device not pictured in the system 100.

In some examples, the third-party service 110 stores and/or provides access to various third-party sources of digital data. For example, the third-party service 110 can be accessed by the host-computing device 102 and/or the computing devices 112 to provide functionality by which the host-computing device 102 and/or computing devices 112 can generate, access, view, search for, and/or interact with digital data. In some instances, the third-party service 110 includes a database storing digital files (e.g., digital documents, digital images, digital videos, etc.). In some examples, the third-party service 110 includes a search engine that provides search results in response to receiving a search query, another social networking service, a gaming service, an e-commerce marketplace, a payment service, a banking service, a remote digital storage service, a cloud computing service, or any other third-party platform hosting one or more services that are accessibly by the host computing device 102 and/or computing devices 112 via the network 114.

The networking component 104, the ER-communication component 106, and/or the 3D relationship component 108 can be implemented and/or hosted by any one or combination of computing devices of the system 100. For example, while FIG. 1 illustrates the networking component 104, the extended reality communication component 106, and/or the 3D relationship component 108 being implemented by the host computing device 102, any or all of these components can be implemented in whole or in part by a different computing device (e.g., one or more of the computing devices 112, the third-party service 110, or any combination thereof). For instance, the networking component 104, the extended reality communication component 106, and/or the 3D relationship component 108 can be implemented or hosted in a distributed computing arrangement with portions of the respective component(s) being executed on multiple different computing devices.

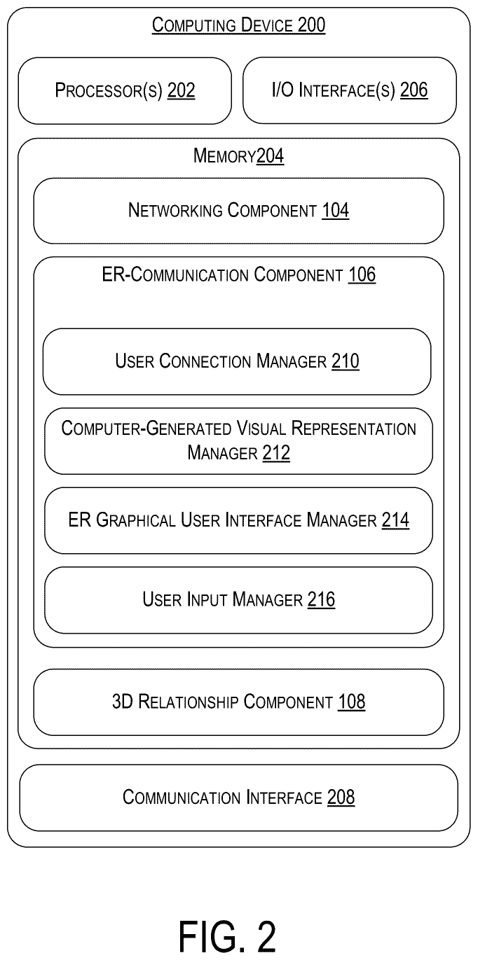

FIG. 2 illustrates an example computing device 200 usable to implement techniques such as those described herein. The computing device 200 can be representative of the host computing device 102, the third-party services 110, and/or the computing devices 112. As shown, the computing device 200 includes one or more processors 202, memory 204, input/output interfaces 206 (or “I/O interfaces 206”), and a communication interface 208, which can be communicatively coupled to one another by way of a communication infrastructure (e.g., a bus, traces, wires, etc.). While the computing device 200 is shown in FIG. 2 having a particular configuration, the components illustrated in FIG. 2 are not intended to be limiting. The various components can be rearranged, combined, and/or omitted depending on the requirements for a particular application or function. Additional or alternative components can be used in other examples.

In some examples, the processor(s) 202 can include hardware for executing instructions, such as those making up a computer program or application. For example, to execute instructions, the processor(s) 202 can retrieve (or fetch) the instructions from an internal register, an internal cache, the memory 204, or other computer-readable media, and can decode and execute them. Executing the instructions can configure a computing device, including, for example, an ER device, to perform operations as described herein. By way of example and not limitation, the processor(s) 202 can comprise one or more central processing units (CPUs), graphics processing units (GPUs), holographic processing units, microprocessors, microcontrollers, integrated circuits, programmable gate arrays, or other hardware components usable to execute instructions.

The memory 204 is an example of a hardware-type (in contrast to a signal type) of computer-readable media and is communicatively coupled to the processor(s) 202 for storing data, metadata, and programs for execution by the processor(s) 202. In some examples, the memory 204 can constitute non-transitory computer-readable media such as one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 204 can include multiple instances of memory, and can include internal and/or distributed memory. The memory 204 can include removable and/or non-removable storage. The memory 204 can additionally or alternatively include one or more hard disk drives (HDDs), flash memory, Universal Serial Bus (USB) drives, or a combination these or other storage devices.

As shown, the computing device 200 includes one or more I/O interfaces 206, which are provided to allow a user to provide input to (such as touch inputs, gesture inputs, keystrokes, voice inputs, etc.), receive output from, and otherwise transfer data to and from the computing device 200. Depending on the particular configuration and function of the computing device 200, the I/O interface(s) 206 can include one or more input interfaces such as keyboards or keypads, mice, styluses, touch screens, cameras, microphones, accelerometers, gyroscopes, inertial measurement units, optical scanners, other sensors, controllers (e.g., handheld controllers, remote controls, gaming controllers, etc.), network interfaces, modems, other known I/O devices or a combination of such I/O interface(s) 206. Touch screens, when included, can be activated with a stylus, finger, thumb, or other object. The I/O interface(s) 206 can also include one or more output interfaces for presenting output to a user, including, but not limited to, a graphics engine, a display (e.g., a display screen, projector, holographic display, etc.), one or more output drivers (e.g., display drivers), one or more audio speakers, and one or more audio drivers. In certain examples, I/O interface(s) 206 are configured to provide graphical data to a display for presentation to a user. The graphical data can be representative of one or more user interfaces, e.g., graphical user interfaces, and/or any other graphical content as can serve a particular implementation. By way of example, the I/O interface(s) 206 can include or be included in a wearable device, such as a head-mounted display (e.g., headset, glasses, helmet, visor, etc.), a suit, gloves, a watch, or any combination of these, a handheld computing device (e.g., tablet, phone, handheld gaming device, etc.), a portable computing device (e.g., laptop), or a stationary computing device (e.g., desktop computer, television, set top box, a vehicle computing device). In some examples, the I/O interface(s) 206 can be configured to provide an extended reality environment or other computer-generated environment.

The computing device 200 also includes the communication interface 208. The communication interface 208 can include hardware, software, or both. The communication interface 208 provides one or more interfaces for physical and/or logical interfaces for communication (such as, for example, packet-based communication) between the computing device 200 and one or more other computing devices or one or more networks. As an example, and not by way of limitation, the communication interface 208 can include a network interface controller (NIC) or network adapter for communicating with an Ethernet or other wire-based network and/or a wireless NIC (WNIC) or wireless adapter for communicating with a wireless network, such as a WI-FI adapter. The communication interface 208 can additionally include a bus, which can include hardware (e.g., wires, traces, radios, etc.), software, or both that communicatively couple components of computing device 200 to each other.

FIG. 2 illustrates the networking component 104, the extended reality communication component 106, and the 3D relationship component 108 implemented by the computing device 200 (e.g., the host computing devices 102, third-party computing device, and/or one or more of the computing devices 112 as discussed above with reference to FIG. 1). As shown, the networking component 104, the extended reality communication component 106, and the 3D relationship component 108 are stored in the memory 204 of the computing device 200. Each of these components, the networking component 104, the extended reality communication component 106, and the 3D relationship component 108, can include computer-executable instructions that are executable by the one or more processors 202. While shown as separate components in this example, in other examples, the networking component 104, the extended reality communication component 106, and/or the 3D relationship component 108 can be combined with one another or grouped in other manners. For instance, in some examples, the networking component 104, the extended reality communication component 106, and the 3D relationship component 108 can all be parts of a single application or computer program. As another example, the extended reality communication component 106 can be part of the networking component 104, and/or the 3D relationship component 108 can be part of the extended reality communication component 106.

In the illustrated example, the extended reality communication component 106 can include a user connection manager 210, a computer-generated visual representation manager 212, an extended reality (“ER”) user interface, e.g., a graphical user interface, manager 214, and a user input manager 216. Also, while not shown, the memory 204 can store data, such as computer-generated visual representations, a social graph or other representation of user connections, user profiles, and/or task profiles associated with the extended reality communication component 106.

The user connection manager 210 can determine connections between a user of a networking component and one or more other users of the networking system. For example, the user connection manager 210 can determine a connection based on a task associated with the user and a task associated with the co-user, recent communications between the user and the co-user, and/or an organizational structure corresponding to an organization associated with the user and the co-user. In some examples, the user connections can be stored and/or represented in the form of a social graph.

The computer-generated visual representation manager 212 can identify one or more computer-generated visual representations to be displayed on an extended reality device. For example, the computer-generated visual representation manager 212 can identify animated visual representations (e.g., avatars), photographs, holograms, or other computer-generated visual representations that correspond to other users determined to have a connection with the user by the user connection manager 210. In some examples, the computer-generated visual representation manager 212 can also provide computer-generated visual representations for display within or in association with the 3D relationship component 108.

The extended reality communication component 106 further includes the extended reality user interface, e.g., a graphical user interface, manager 214, which provides visual elements for display within an extended reality user interface, e.g., a graphical user interface, displayed on an extended reality device. For example, the extended reality user interface, e.g., a graphical user interface, manager 214 can provide one or more extended reality lobby user interface, e.g., a graphical user interface, elements. Further, the extended reality user interface, e.g., a graphical user interface, manager 214 can provide one or more computer-generated visual representations selected by the computer-generated visual representation manager 212 for display within the extended reality lobby user interface, e.g., a graphical user interface, element(s). In some examples, the extended reality user interface, e.g., a graphical user interface manager 214 can also provide visual elements for display within or in association with the 3D relationship component 108.

Additionally, the extended reality communication component 106 includes the user input manager 216, which can receive or otherwise detect user input. For example, the user input manager 216 can receive voice input, touch input, eye tracking input, gesture input (e.g., hand tracking, head tracking, body language, facial expressions, etc.), and/or input via a controller device associated with the extended reality communication component 106. In some instances, the user input manager 216 communicates the received user input with the extended reality user interface, e.g., a graphical user interface, manager 214 so that the extended reality user interface, e.g., a graphical user interface manager 214 can change the visual elements provided for display on the extended reality device. In some examples, user input received via the user input manager 216 can also be used in association with the 3D relationship component 108.

As discussed above with reference to FIG. 1, the 3D relationship component 108 is configured to receive an input from a computing device (e.g., the computing device 102(A) of FIG. 1), and generate a visual representation of terms included in the input. For example, the input-processing component 118 of the 3D relationship component 108 determines a semantic meaning of the input and identifies terms in the input based on the semantic meaning. The input-processing component 118 can identify the terms based on parts of speech, such as nouns included in the input that can correspond to objects in an extended reality environment and verbs that can correspond to actions associated with the identified nouns. The input-processing component 118 can utilize a machine-learned model, such as a deep neural network, to determine the semantic meaning and/or to identify the terms.

Once the terms are identified, the 3D relationship component 108 can generate a 3D representation of a relationship between the terms, and provide the 3D representation to a computing device for display. In some instances, the 3D relationship component 108 generates a 3D representation of a modification to an object in an extended reality environment using the object manipulation component 120.

Also, as discussed above, the memory 204 can store, among other things, computer-generated visual representations, user connections, an object library of virtual objects, and/or task profiles. In some examples, the computer-generated visual representations can include visual representations (e.g., animations, photographs, holograms, etc.) that correspond to the users of the networking component. The computer-generated visual representations can be selectable by the computer-generated visual representation manager 212 for display in association with the networking component 104, the extended reality communication component 106, the 3D relationship component 108, or any other application of the computing device 200. The user connections can store associations determined between users of the networking component 104 by the user connection manager 210. In examples, the memory 204 can store task profiles generated for the users of the networking component 104. The user connection manager 210 can utilize the stored task profiles to determine connections between users in some instances. Though not shown, the memory 204 can store various other forms of digital data such as, but not limited to, a social graph, user profiles, digital objects or messages that are passed from one user of a networking component to a co-user of the networking system, or the like.

While in this example, various components and/or managers are shown as being stored in the memory 204, it should be understood that this is but one example and that the functionality described herein as being attributable to these components and/or managers can be implemented in software, hardware, or both. For example, any or all of these components and/or managers can include one or more instructions stored on a computer-readable medium, e.g., a computer-readable storage medium such as a hardware storage device, or alternatively a computer-readable medium including a signal, and executable by processors of one or more computing devices, such as the host computing device 102, the third-party service 110, and/or one or more of the computing devices 112. When executed by the one or more processors, the computer-executable instructions of the extended reality communication component 106 can cause the computing device(s) to perform the methods described herein. Alternatively or additionally, the components and/or managers can include hardware, such as a special-purpose processing device to perform a certain function or group of functions. In some cases, the components and/or managers can include a combination of computer-executable instructions and hardware.

Furthermore, in some examples, any or all of the components and/or managers can be implemented as one or more operating systems, as one or more stand-alone applications, as one or more modules of an application, as one or more plug-ins, as one or more library functions application programming interfaces (APIs) that can be called by other applications, and/or as a cloud-computing model. In some instances, the components and/or managers of the networking component 104, the extended reality communication component 106, and/or the 3D relationship component 108 can each be implemented as a stand-alone application, such as a desktop or mobile application, as one or more web-based applications hosted on a remote server, and/or as one or more mobile device applications or “apps.”

The methods described herein are not limited to being performed using the systems and/or devices described regarding FIG. 1 and/or FIG. 2 and can be implemented using systems and devices other than those described herein.

Clones, copies, or instances of one or more avatars, e.g., of the body and movement and/or associated sounds made by the user of a user of an ER-compatible device, can be generated and/or initiated at and/or activated by a first or primary instance of a user's avatar or graphical representation in the ER environment and/or by new, other, or secondary instance(s) of a new avatar or new graphical representation of the user in the ER environment. Avatars can be generated and/or initiated and/or activated via one or more of voice control, e.g., a wake word; gaze control; a dedicated or assigned gesture; activation of a hardware and/or software button associated with the technology; and/or a physical and/or virtual power glove type technology, which can include one or more of virtual controller(s) associated with the user's hand(s), a wrist band, a haptic-enabled controller, including a physical haptic glove; etc. The avatar can be controlled by the user via an ER-compatible device. In examples, an individual avatar of a plurality of avatars can have one or more presentations that differ from another individual avatar of the plurality of avatars, e.g., one or more of: different color, different character representation, perform different actions, perform actions at different speeds, perform a series of actions, perform actions repeated in a loop for a predetermined amount of time and/or until canceled; produce different sounds, present different sound characteristics, e.g., tone, speed, etc., produce a series of sounds, produce sounds repeated in a loop for a predetermined amount of time and/or until canceled, etc. In some examples, different control schemas can employ different algorithms to effect control of the avatars(s) independently, in unison, and/or in tandem.

In at least one example, a user can be wearing a power-glove on one, a first, hand, can press a button associated with the power glove to generate a first avatar of themselves, can control movement and/or sound of the first avatar, and can record movement, sound, and/or environment associated with the first avatar to produce a second avatar that presents the recorded movement, sounds, and/or environment independent of the first avatar. New avatar(s) can be produced at predetermined and/or ad-hoc locations as desired. The recordings can be manipulated so that the presentation of the new avatar(s) include changes to the recording such as changing the appearance of the new avatar, changing recorded motion, such as speed, and sound, such as changing the voice, modulation, speed, etc. This can be repeated as many times as the user desires, e.g., to perform virtual bodystorming, create virtual demos with multiple avatars operating independently from each other, interacting with each other, etc. For example, if three independent avatars are desired, after producing the second avatar, the user can move the first avatar to a new of different location, e.g., next to, across from, parallel to, diagonal from, within arm's distance away from the second avatar, more than arm's distance away from the second avatar, more than three feet away from the second avatar, in a location remote from the second avatar (including in a different virtual room, building, elsewhere in the virtual world, etc.) etc., control movement and/or sound of the first avatar, and record the movement and/or sound of the first avatar to produce a third avatar that performs the recorded movement and/or sounds independent of the first avatar or second avatar. In some examples, location(s) for placement of one or more avatars can be pre-designated. If interaction of the avatars is desired, e.g., for virtual bodystorming, the avatars will generally be in a shared space, e.g., a virtual room.

In examples, the user can use an input system, e.g., controller, mouse, etc., and/or the user can be wearing a physical and/or virtual power-glove type technology (as discussed above) on at least one hand. In at least one example, the user can press a button associated with the power glove type technology (as discussed above) to generate a first avatar of themselves, can control movement and/or sound of the first avatar by moving the user's body and/or making sounds, and can record the movement and/or sound to be associated with and/or represented by the first avatar. In examples, the user can generate a first avatar of themselves by performing a defined gesture, e.g., a praying gesture, a clapping gesture, a maestro gesture akin to a conductor conducting an orchestra, etc., with or without the user wearing a power-glove and/or similar sensing device. In some examples a defined generating gesture and/or button push can be combined with one or more of a voice command, gaze control, etc. to initiate generating an avatar and/or control starting and/or stopping recording of the movement and/or sound to be associated with and/or represented by the first avatar. Generating avatars can be repeated as many times as the user desires.

In some examples one avatar, e.g., a second avatar, can interact with another avatar, e.g., a first avatar, to generate a yet another avatar. For example, the second avatar can virtually press a button associated with a representation of a power glove presented associated with the first avatar to generate a third avatar. Movement and/or sound of the user made after generation of the third avatar can be recorded and associated with and/or represented by the third avatar.

In examples, one or more of the avatars, e.g., the first avatar, can move around the environment to provide different views/perspectives such as a view of a room, a view of individual of the avatars from different perspectives, a view of a group of avatars from different perspectives, etc. Images from the perspective(s) of one or more avatar(s) can be presented to the user in one or more of a variety of formats such as a primary presentation identified according to the perspective of an identified avatar, e.g., the perspective of a first avatar, the perspective of a designated avatar, etc., and/or in a cycle of perspectives of multiple avatars aka carousel controlled by any of the techniques described above, and/or in a combined presentation such as picture-in-picture, panoramic, stitched, collage, etc.

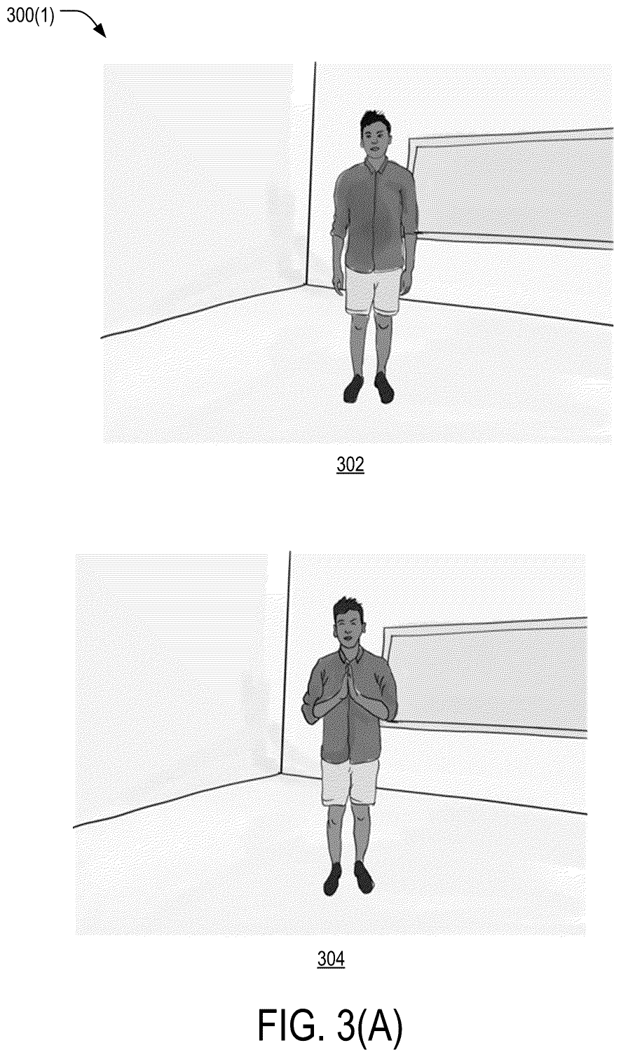

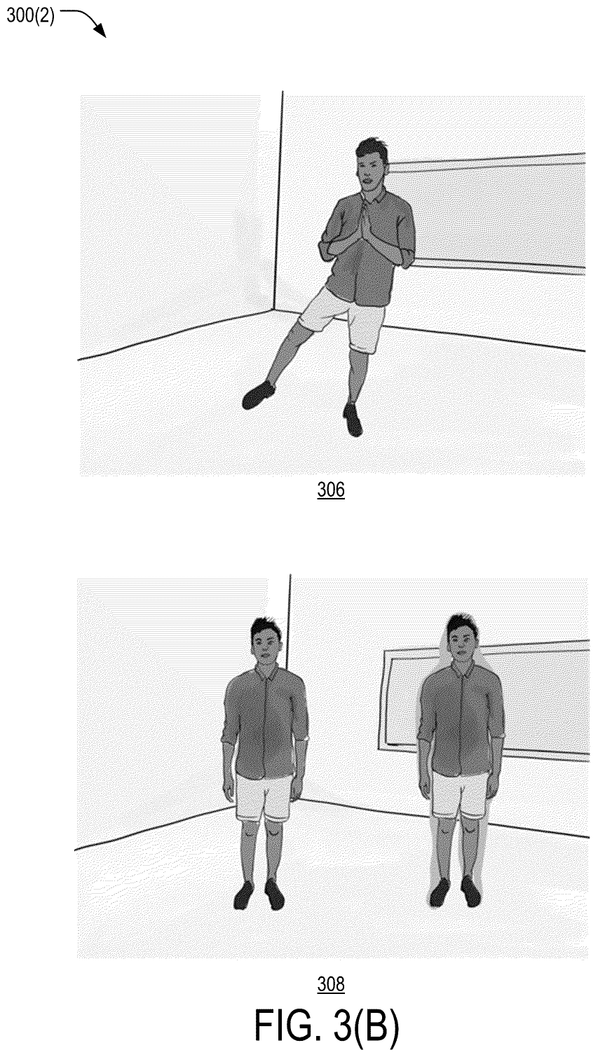

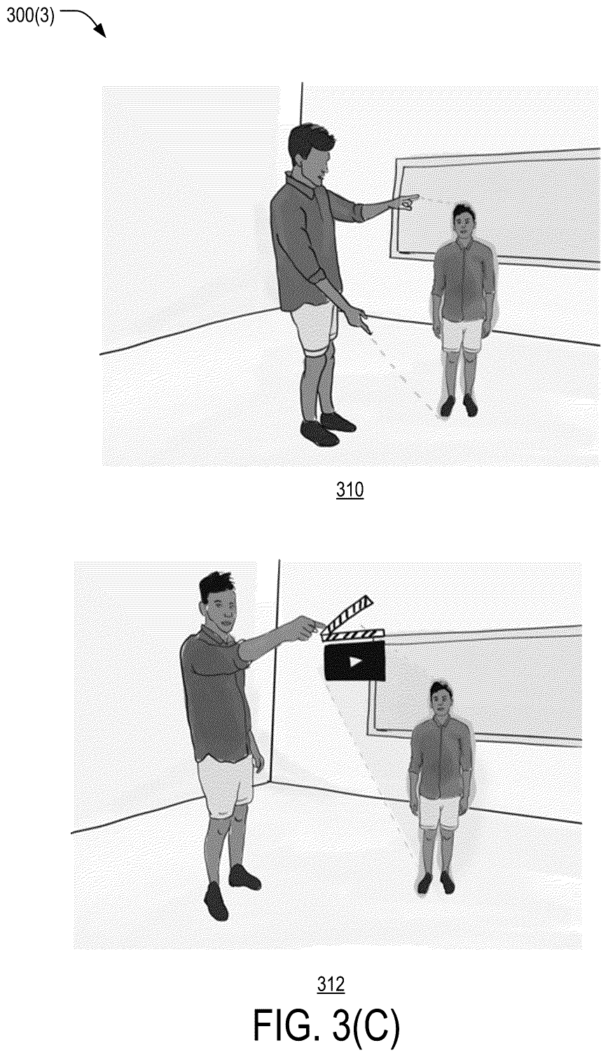

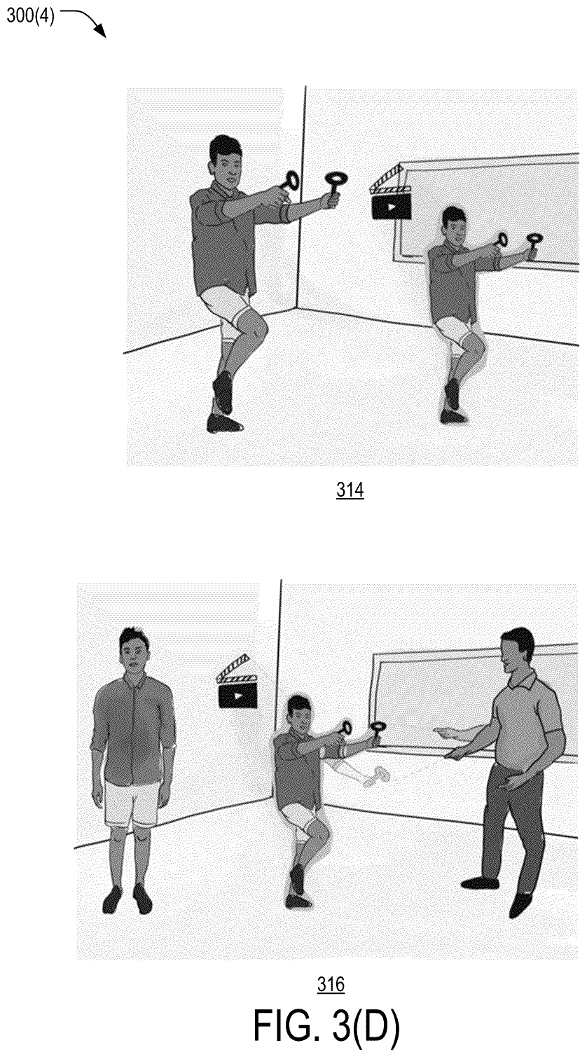

FIG. 3(A), FIG. 3(B), FIG. 3(C), and FIG. 3(D) illustrate an example of the technology described herein in use to create, replicate, and/or control avatars and/or objects in an extended-reality environment. In various examples, a user can employ an interface like that described in the patent application, “Technology for Replicating and/or Controlling Objects in Extended Reality,” to implement the described technology.

One non-exclusive example use of the technology described herein is when a designer is prototyping and needs two (or more) participants to bodystorm an idea. The technology described herein can generate a clone, e.g., from a user's body, and manipulate the rig to bodystorm and create a video prototype.

Another non-exclusive example use of the technology described herein is when a user wants to communicate with someone with more full context than an email, message, or text provides, particularly when synchronous communication is not feasible. In such examples, the technology can be configured to record a 3D replica of a user's communication and provide the 3D replica to share their speech, facial expressions, and/or body language asynchronously.

FIG. 3(A) at 300(1), presents the first set of a series of images that illustrate a way that the technology can be configured and used.

Image 302 illustrates a user working alone who wants to communicate with one or more team members who are not with the user, e.g., the user may need to explain an idea to team members who are not co-located. In at least one example, the technology described herein can generate a clone, e.g., from a user's body, and manipulate the rig to bodystorm and create a video prototype. In at least one example, outside of bodystorming and/or prototyping any user may want to communicate with someone with more full context, e.g., when synchronous communication, such as via video-chat, is not feasible. In at least one example, the technology can be configured to record a 3D-replica of a user's communication and provide the 3D-replica to share the user's speech, facial expressions, and/or body language asynchronously in a mixed reality communication.

Image 304 illustrates that a user, employing the technology described herein, can initiate generation of an avatar of their body by placing their palms together at chest height (or another predetermined gesture).

FIG. 3(B) at 300(2), presents the second set of the series of images that illustrate the way that the technology can be configured and used. For example, series 300(2) can represent additional images from a session including the series 300(1). Image 306 illustrates that, employing the technology described herein, after performing the initiation gesture, the user can step out of the space they'd been occupying. Image 308 illustrates that the technology can produce a replica of the user at the previous position, with height and mesh structure corresponding to the user.

FIG. 3(C) at 300(3), presents the third set of the series of images that illustrate the way that the technology can be configured and used. For example, series 300(3) can represent additional images from a session including the series 300(1) and/or 300(2). Image 310 illustrates that the technology enables the user to control the size of the replica, e.g., to represent a larger person by increasing the height of the mesh (not shown) or to represent a smaller person like a child by reducing the height of the mesh.

Image 312 illustrates that the technology enables the user to add one or more virtual cameras to record a scene including the newly sized replica in mixed reality. In various examples, the technology can facilitate a scene that can include multiple replicas, virtual objects, and/or camera(s), any of which can be animated using the technology. In various examples, the technology facilitates recording the user's speech, facial expressions, body language, etc., to be sent, e.g., as a file, via a communication channel such as via text messaging, e.g., SMS and/or MMS, an instant messaging service, email, etc.

FIG. 3(D) at 300(4), presents the fourth set of the series of images that illustrate the way that the technology can be configured and used. For example, series 300(4) can represent additional images from a session including the series 300(1), 300(2), and/or 300(3).

Image 314 illustrates that the technology enables a user to hold a virtual controller, perform body movements, which can be recorded by a tracker, and that the recorded body movements can be applied to the replica mesh as a replay, thereby animating the rig to create a scene and/or story. In various examples, the tracker can include one or more of, e.g., an optical tracking system, a computer-vision (CV) based system, AI-based systems, etc. In some examples, the technology can be configured to generate additional replicas performing different actions and/or interacting with each other in the same scene.

Image 316 illustrates that, in some examples, the technology can facilitate another user changing the action the replica is performing. The technology may enable the other user to manipulate the replica to change the action. For example, the other user may select body joints from a tracker, e.g., an optical tracking system, a computer-vision (CV) based system, AI-based systems, etc., and manipulate the replica's transform and rotation to create the movement desired by the other user. In some examples, other user may also select the starting point and time, and the final destination and time. In some examples, the technology may automatically animate the rig/joint for the other user. Thus, the technology can enable multiple users to interact with the same replica rig to replicate body movements of the multiple users to arrive at a design upon which they agree.

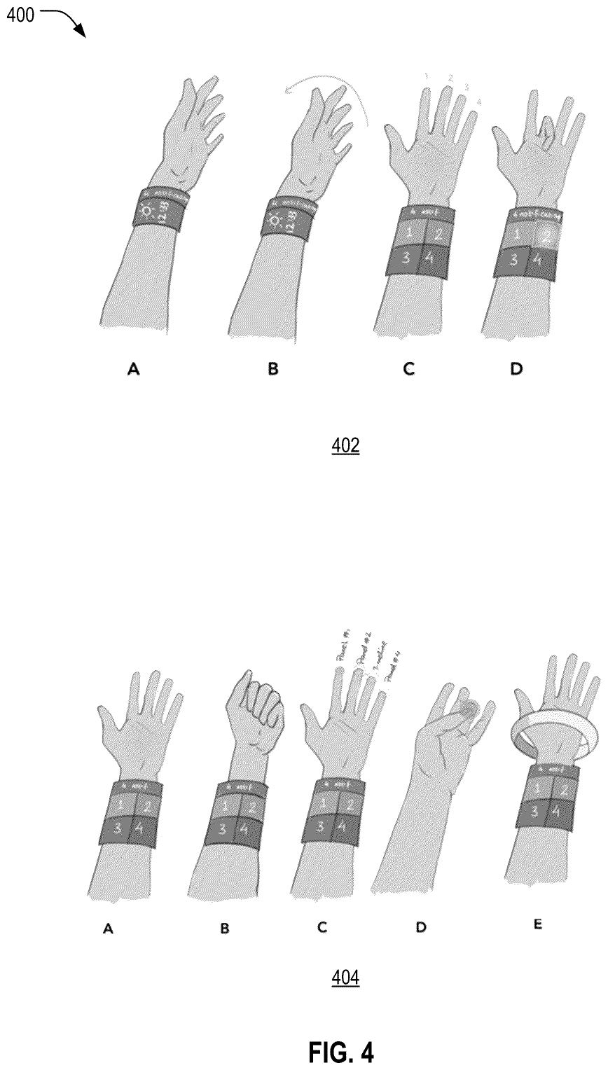

FIG. 4 at 400 presents a set of images that show a way that the technology described herein can be configured and used via an example controller. Clones, copies, or instances can be generated and/or initiated and/or activated via voice control, e.g., a wake word; gaze control; a gesture; activation of a hardware and/or software button associated with the technology; and/or a wearable technology such as a wrist band, glove, and/or power glove type technology; etc.

Image 402 presents an example controller, e.g., a wristband-style controller, which can facilitate a user using gestures relative to their body and/or the controller to control the technology described herein. In some examples, the controller can be associated with an extended-reality headset. In various examples, the controller alone or in conjunction with an extended-reality headset can identify a user using their hand, palm, and fingers in particular gestures, and control the technology described herein according to the identified gestures.

Drawing A in image 402 illustrates a first panel associated with a wristband in an initial and/or inactive state, which can show a notification count and a widget for time, battery, weather, etc. Drawing B in image 402 illustrates the first panel recognizing activation based on rotation of the arm. Drawing C in image 402 illustrates a second panel replacing the first panel. In this example, the second panel is a user interface (UI) panel that includes 4 buttons (numbered 1, 2, 3, 4, for ease of illustration), which are contextual to the scene and the activity of the user. Drawing D in image 402 illustrates that a button can be selected by a user using their fingers. In some examples, each finger can be a linked to a particular button, and the user can tap on the palm to select a button. In various examples, the user can use their other hand to select a button.

Image 404 presents the example controller, e.g., a wristband-style controller, which can facilitate a user using gestures relative to their body and/or the controller to control the technology described herein in a contextually relevant scenario as introduced in 402. Drawings A and B in image 404 illustrate one way a user can initiate a change in the button panel to another contextually relevant scenario, e.g., by closing their hand, bringing all their fingers to their palm together. Drawing C in image 404 illustrates the user reopening their hand to complete the gesture. In some examples, the gesture represented by Drawings A, B, and C can initiate a process for the technology to identify that the user intends to change the panel. On opening the hand, extending the fingers from the palm, the technology can provide an interface of options for available panels as shown in Drawing C in image 404. In the illustrated example, each finger can represent a particular panel system. Drawing D in image 404 illustrates that the technology can receive input to the interface of options for available panels by the user using their thumb to press the finger associated with the panel they wish to select. Drawing E in image 404 illustrates the technology opening the panel linked to that finger and providing the buttons for the user to as appropriate to the contextually relevant scenario.

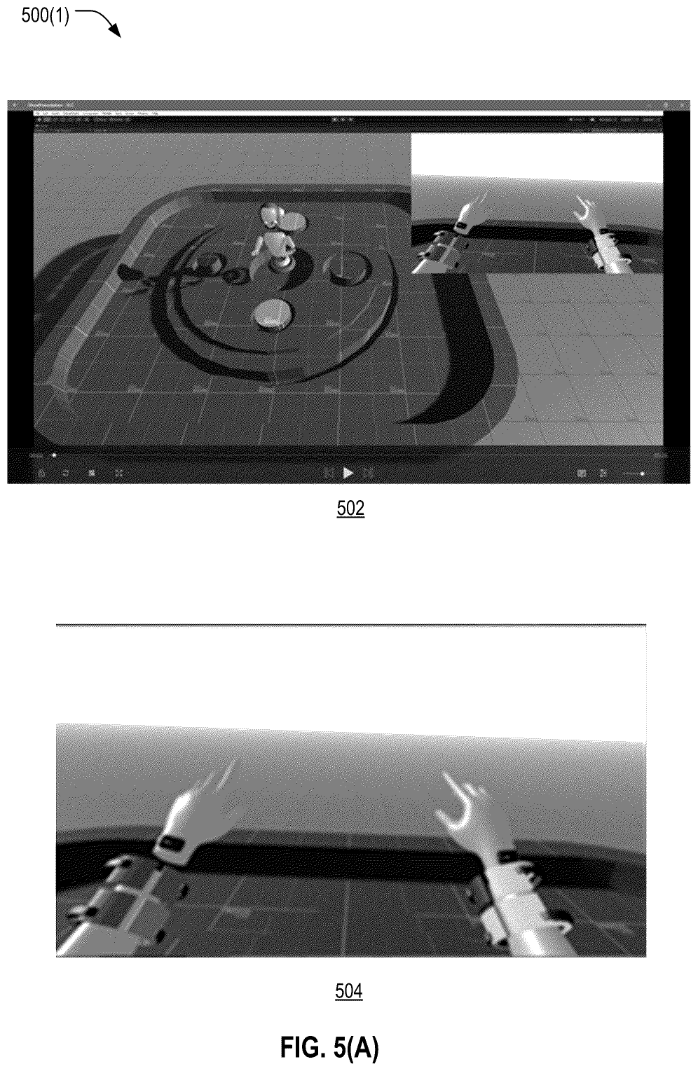

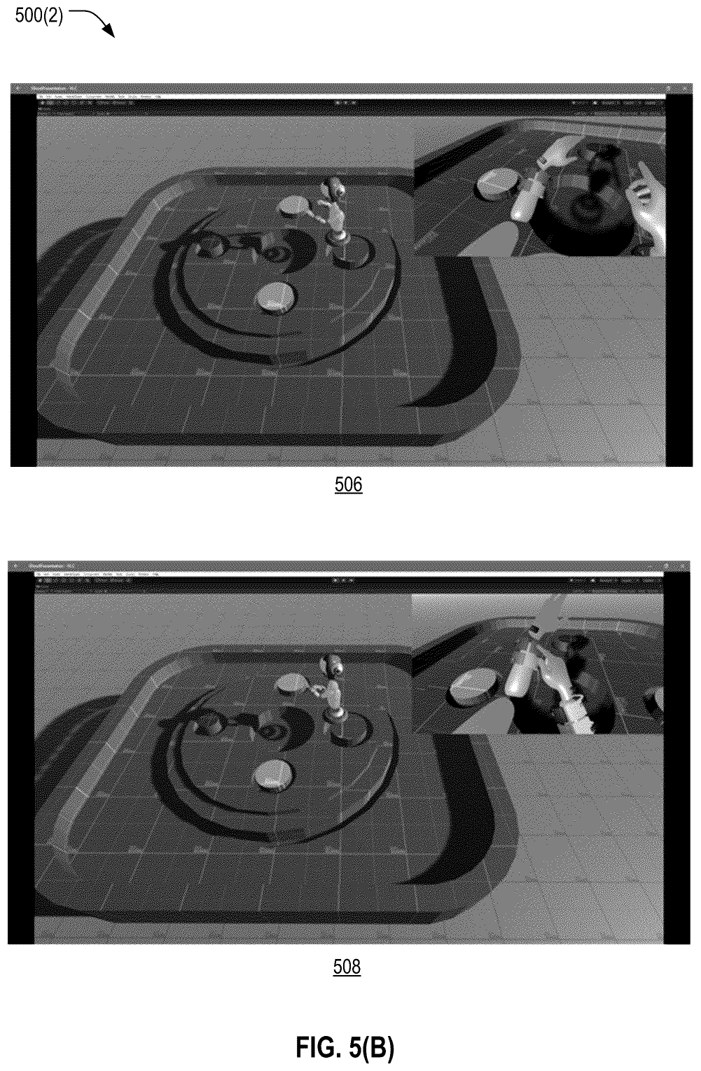

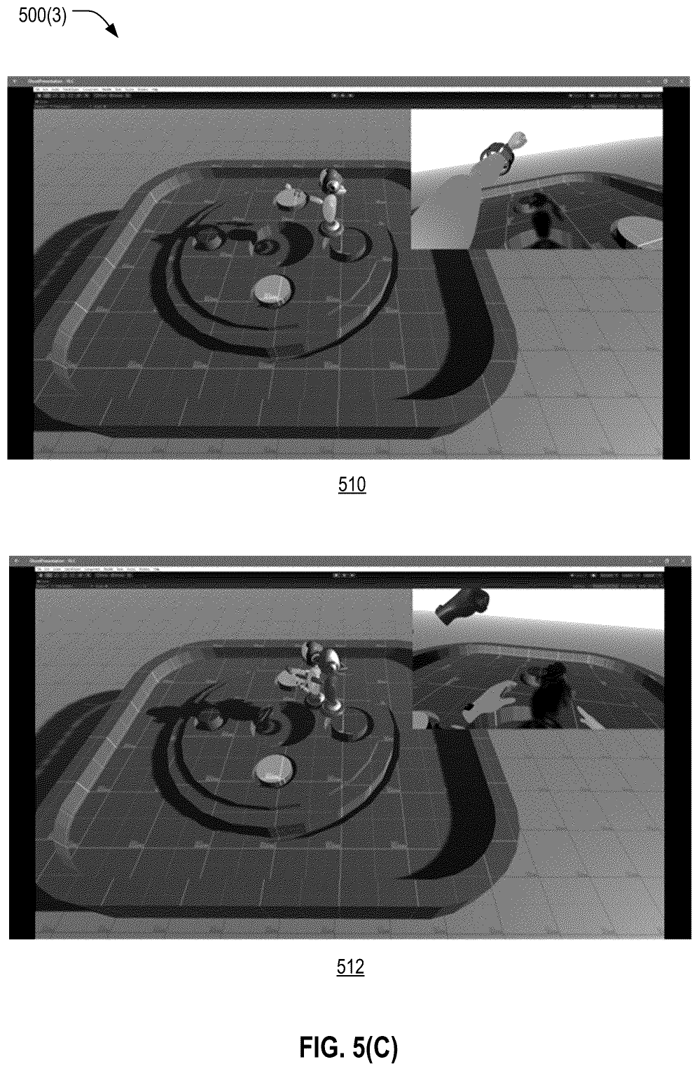

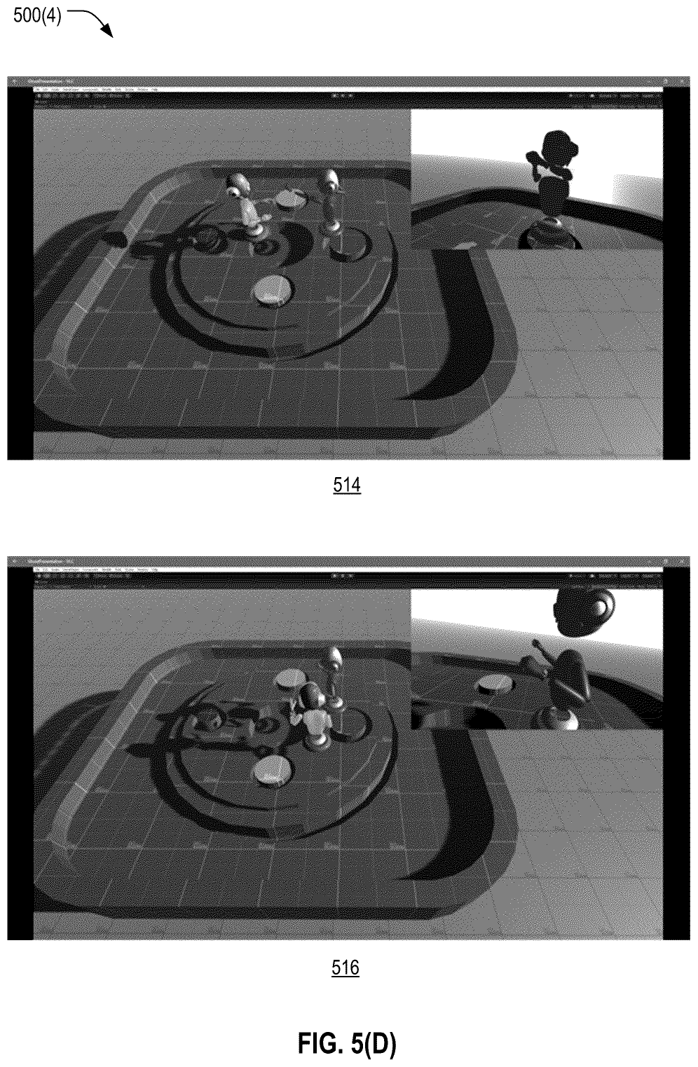

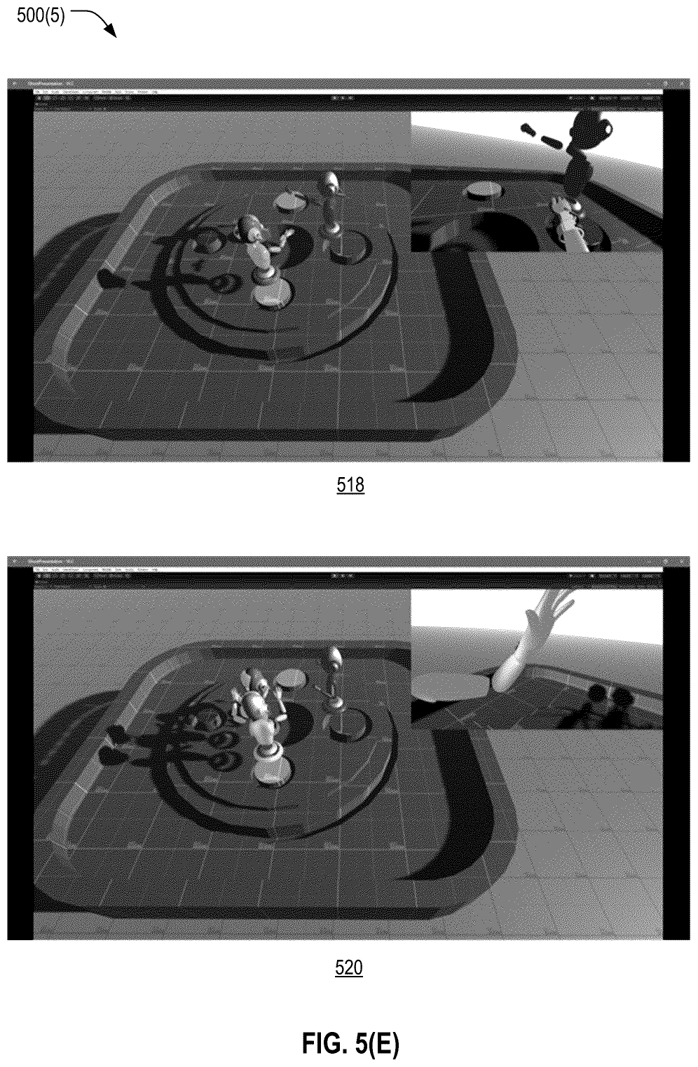

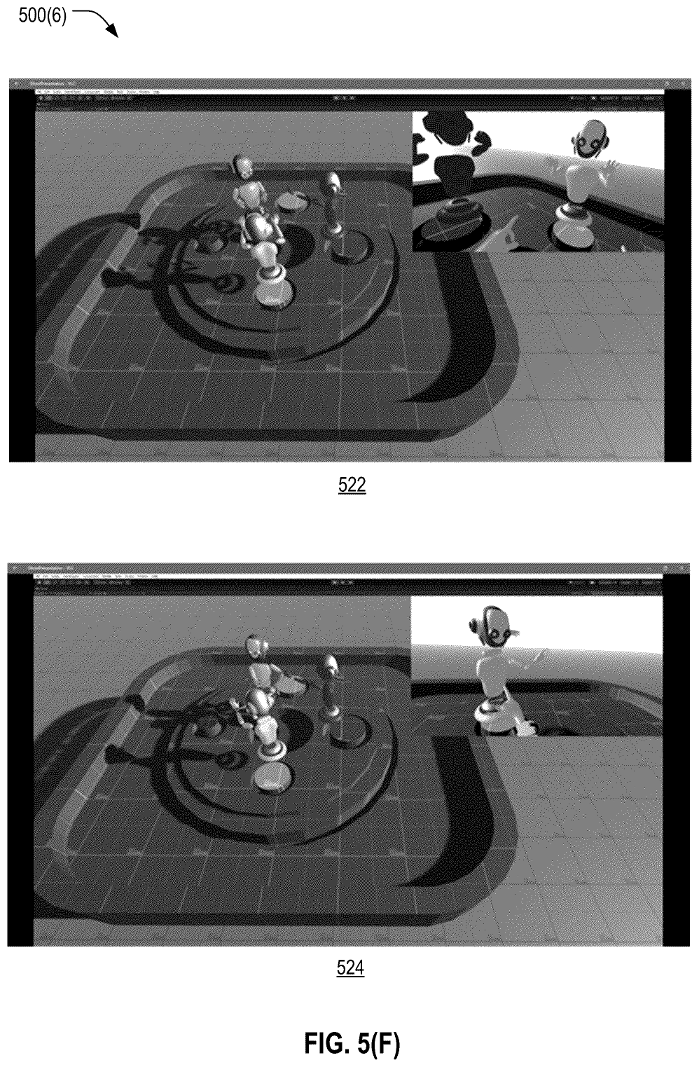

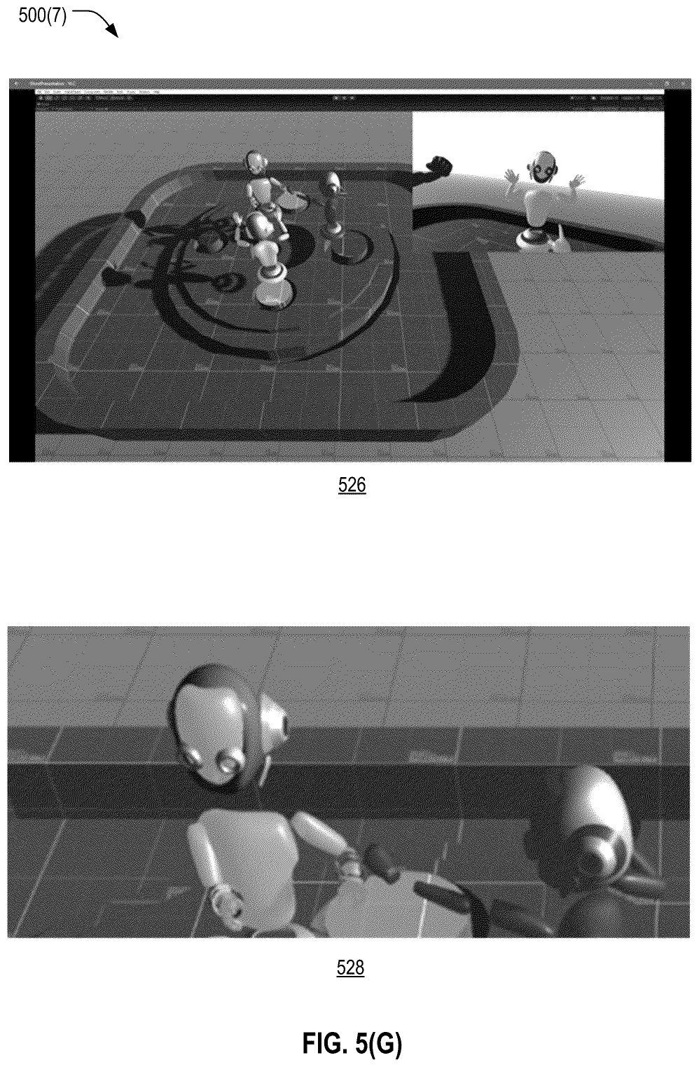

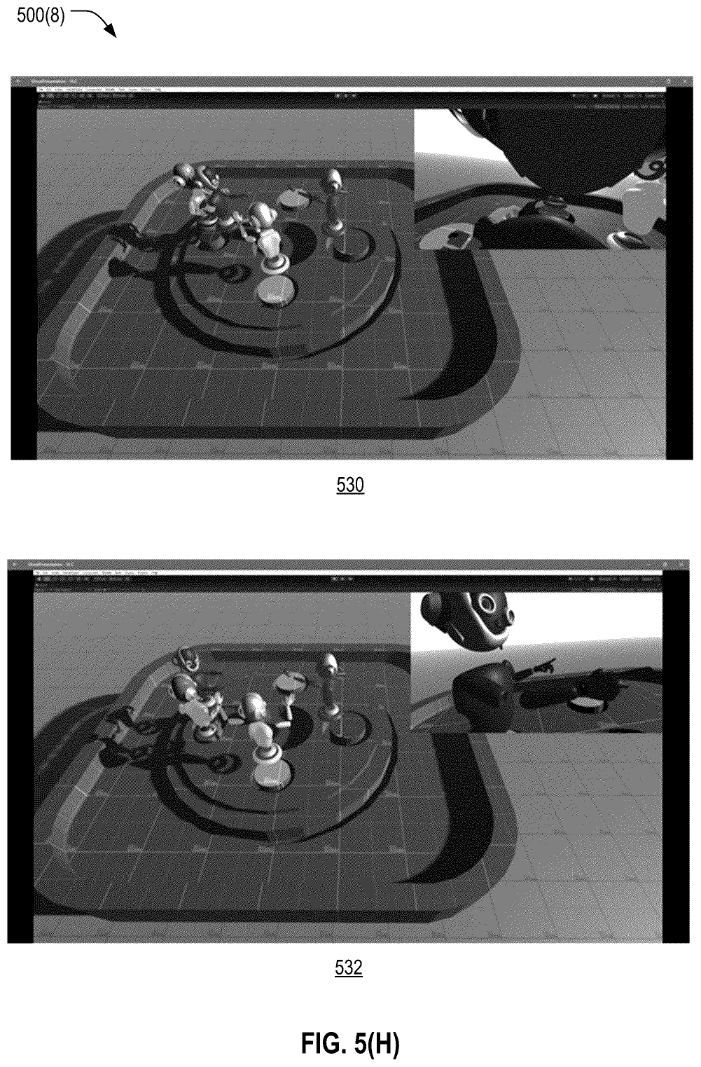

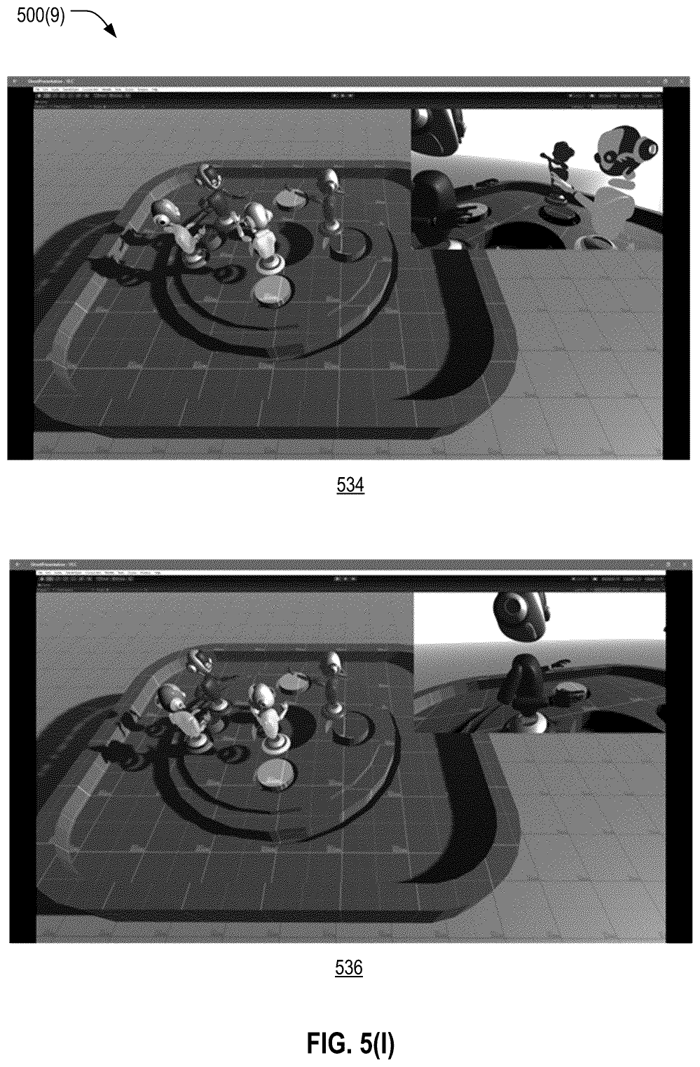

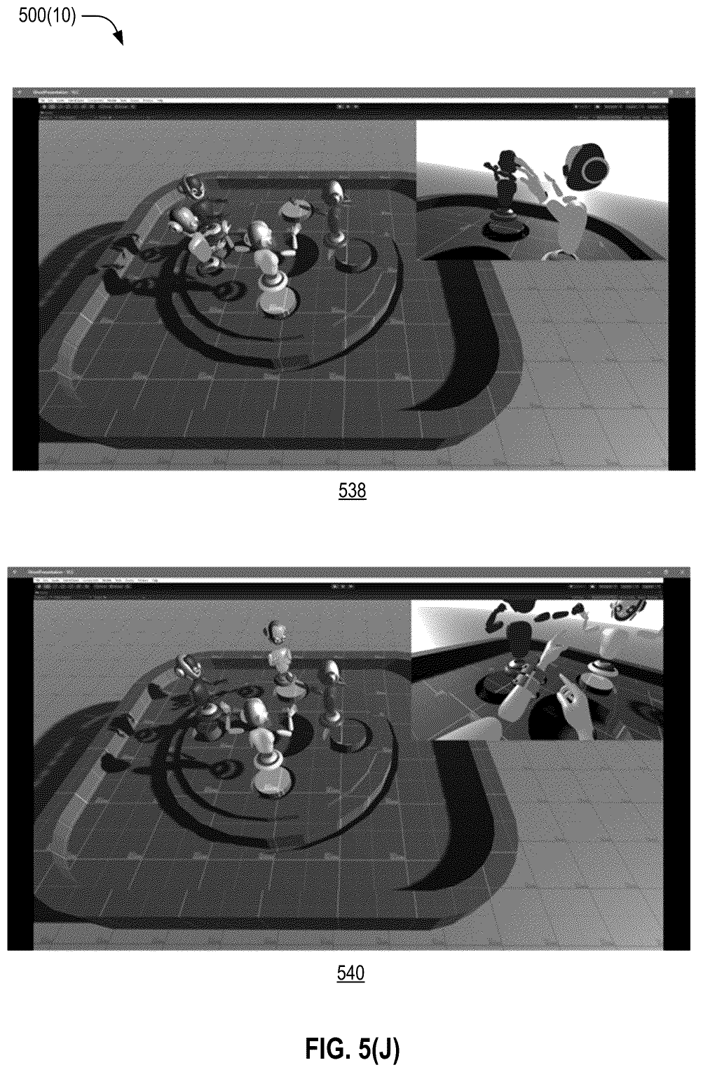

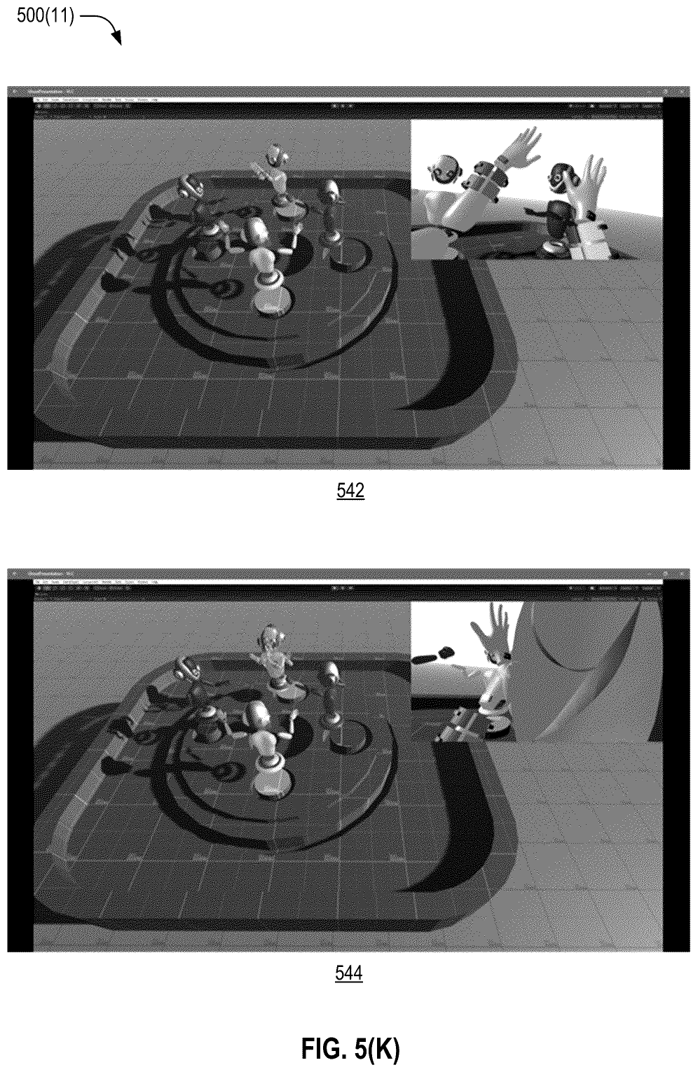

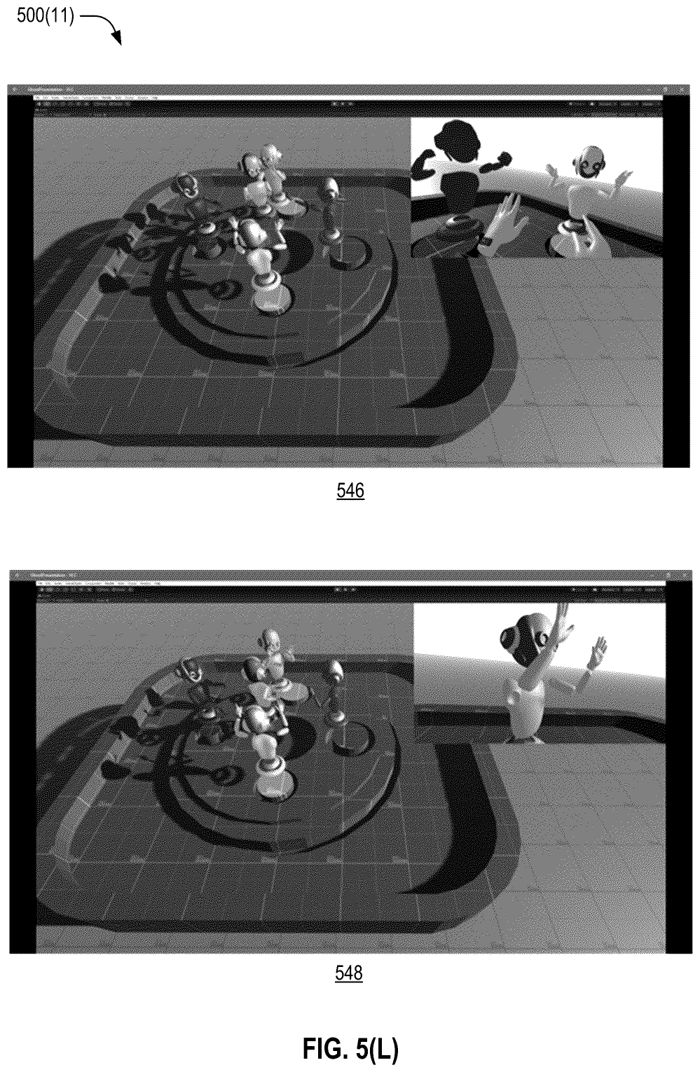

FIGS. 5(A)-5(L) illustrate an example of the technology described herein in use in an extended reality (ER) environment via screen captures from a recording of an example prototype being operated by an individual. This example ER environment includes four pre-designated locations for respective avatars, e.g., for interaction with each other in an experience, game, etc. This example is described by designating the four pre-designated locations north, south, east, west, akin to map directions. However, other example can include more or less than four pre-designated locations, and some examples may not include pre-designated locations at all.

FIG. 5(A) at 500(1), presents the first set of a series of images that illustrate an example prototype in operation. Image 502 illustrates a primary avatar, e.g., of a user, in an ER environment. Image 502 includes a representation of power gloves shown in a picture in picture presentation corresponding to the line-of sight perspective of the primary avatar. Image 504 zooms in on the representation of the power gloves from the picture in picture presentation corresponding to the line-of sight perspective of the primary avatar. The individual can interact with the power gloves to control some operations of the prototype.

FIG. 5(B) at 500(2), presents the second set of the series of images that illustrate the example prototype in operation. Image 506 illustrates that the primary avatar can move to a designated location in the ER environment, in this example, the east designated location. The individual can control this movement via movement of their own body.

Image 508 illustrates that the user can press a button associated with a power glove the user is wearing to indicate that the user wants to produce another avatar, which can be presented in the ER environment as the primary avatar pressing a virtual button associated with virtual representation of the power glove the user is wearing to indicate that the user wants to produce another avatar. In some examples, there can be a programmable and/or programmed delay for recording to begin, e.g., 1-30 seconds, 3 seconds, 5 seconds, etc., in order for the user to adopt a position desired for the beginning of the recording after the technology receives an indication to produce a new avatar, e.g., to avoid the new avatar performing the action of indicating a new avatar should be produced.

FIG. 5(C) at 500(3), presents the third set of the series of images that illustrate the example prototype in operation. Image 510 illustrates that the user can perform actions or strike one or more poses for the designated period of time associated with producing a new avatar, which in this example is a first new avatar. Image 512 illustrates that after the designated period of time, the technology produces that new avatar in that location, and the primary avatar can move to another location. In the illustrated example, the first new avatar is striking a punching pose.

FIG. 5(D) at 500(4), presents the fourth set of the series of images that illustrate the example prototype in operation. Image 514 illustrates that the primary avatar has moved to a location central to the four pre-designated locations. In this example, image 514 provides a picture in picture view from the perspective of the primary avatar facing the first new avatar.

Image 516 illustrates that the new avatar can loop through the recording of the motion or posing while the primary avatar can move around the new avatar in any direction, e.g., 360-degrees around the new avatar in the horizontal plane, above the new avatar in the vertical, and even below the new avatar when the environment is configured for that, e.g., when the environment includes multiple levels associated with the vertical plane, or any combination thereof.

FIG. 5(E) at 500(5), presents the fifth set of the series of images that illustrate the example prototype in operation.

Image 518 illustrates that the user can move their primary avatar to another designated location in ER environment, in this example to the south designated location. Image 518 illustrates that the user can cause their primary avatar to perform actions or strike a pose for the designated period of time associated with producing a new avatar, e.g., a second new avatar. Again, the user can press a button associated with a power glove the user is wearing to indicate that the user wants to produce another avatar, which can be presented in the ER environment as the primary avatar pressing a virtual button associated with virtual representation of the power glove the user is wearing to indicate that the user wants to produce another avatar. In the illustrated example, the user is moving like a conductor conducting an orchestra for the time associated with producing the second new avatar.

Image 520 illustrates that after the designated period of time, the second new avatar is produced in that location, and the primary avatar can move to another location, e.g., the primary avatar can move toward a location central to the four pre-designated locations. In the illustrated example, the second new avatar is performing motions like a conductor conducting an orchestra.

FIG. 5(F) at 500(6), presents the sixth set of the series of images that illustrate the example prototype in operation.

Image 522 illustrates that individual clones, copies, or instances with copies of graphical representations of both left hand and right hand are being controlled independently in unison. The first and second new avatars can loop through their respective recordings of motion or striking a pose while the primary avatar can move around the new avatars in any direction. Image 522 presents the example of the perspective of the primary avatar in picture in picture.

Image 524 illustrates that the technology can be useful for identifying glitches or bugs in other programs, such as, for example, the apparent disappearance of the representation of the right arm and hand of the second avatar as shown in this picture in picture. This feature can be particularly useful when bodystorming for new video games, for example.

FIG. 5(G) at 500(7), presents the seventh set of the series of images that illustrate the example prototype in operation.

Image 526 illustrates that the representation of the right arm and hand of the second avatar reappeared shortly thereafter. Thus, a designer can use the technology described herein to troubleshoot aspects of games they are designing. The technology described herein provides a powerful tool for an individual to plan and/or test interaction of multiple digital avatars.

Image 528 illustrates that another avatar can activate the process to produce a new avatar by interacting with the primary avatar. In the example shown in image 526, the first new avatar activates the virtual button on the virtual power glove of the primary avatar indicating that another new avatar should be produced.

FIG. 5(H) at 500(8), presents the eighth set of the series of images that illustrate the example prototype in operation.

Image 530 illustrates that the primary avatar moved toward the west designated location, and the third new avatar was produced with the movement toward that location. In other examples, the primary avatar can be at any location when a new avatar is produced. A new avatar need not be produced at a predetermined location, though predetermining locations can be desirable for interactions like body storming.

Image 532 illustrates that the third new avatar is performing a slide back and pointing motion, which was recorded as the primary avatar moved to the west designated location.

FIG. 5(I) at 500(9), presents the ninth set of the series of images that illustrate the example prototype in operation. Image 534 illustrates the beginning of the recording loop of the third new avatar. The picture in picture presents the perspective of the primary avatar facing east. Image 536 illustrates the third new avatar sliding back toward the west designated location in the loop. The picture in picture presents the perspective of the primary avatar facing north when located to the south of the third new avatar.

FIG. 5(J) at 500(10), presents the tenth set of the series of images that illustrate the example prototype in operation. Image 538 illustrates the third new avatar pointing with its right hand during the loop. The sequence of picture in picture views in images 532 to 538 provides the perspective of the primary avatar representing the user looking back and forth from left to right after the third new avatar was created.

Image 540 illustrates that the user can move the primary avatar to another designated location in the ER environment, in this instance to the north designated location, and can cause the primary avatar to perform actions or strike a pose for the designated period of time associated with producing a new avatar, e.g., a fourth new avatar. Again, in this example, the user can press a button associated with a power glove the user is wearing to indicate that the user wants to produce another avatar, which can be presented in the ER environment as the primary avatar pressing a virtual button associated with virtual representation of the power glove the user is wearing to indicate that the user wants to produce another avatar as shown in the picture in picture of image 540.

FIG. 5(K) at 500(11), presents the eleventh set of the series of images that illustrate the example prototype in operation. Image 542 illustrates that the user is dancing with their hands raised for the time associated with producing the fourth new avatar.

Image 544 illustrates that after the designated period of time, the fourth new avatar is produced in that location. One of the raised hands of the fourth new avatar is visible in the picture in picture from the perspective of the primary avatar, though mostly the picture in picture shows a close-up view of the head of the fourth new avatar.

FIG. 5(L) at 500(12), presents the twelfth set of the series of images that illustrate the example prototype in operation. Image 546 illustrates that the primary avatar can move to another location. In image 546 the primary avatar is moving toward a location central to the designated locations. The picture in picture shows the perspective of the primary avatar facing south-east. Image 548 illustrates that the primary avatar can move around the ER environment and provide views from their perspective in the picture in picture while the new avatars can loop through their respective recordings of motions or striking poses.

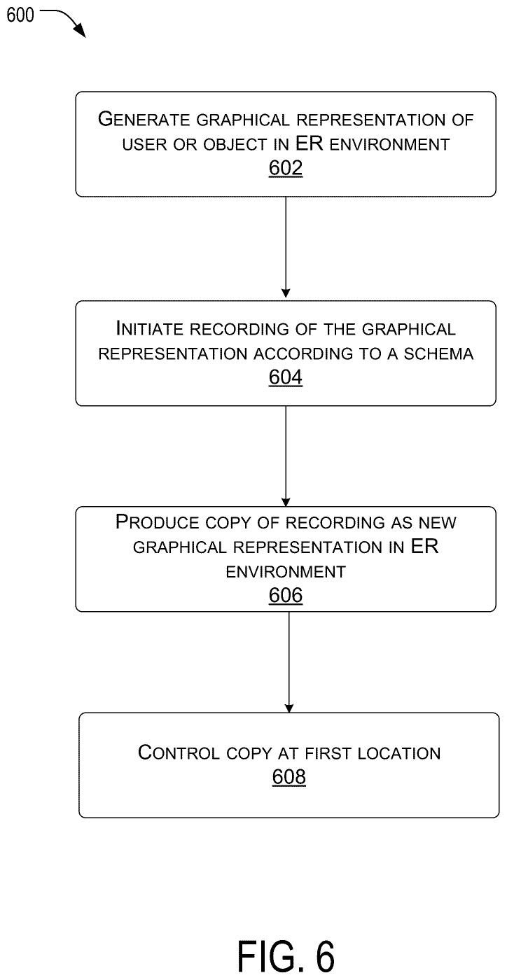

FIG. 6 is a flowchart illustrating an example process 600, employing the technology described herein.

Block 602 represents generating, e.g., via an extended-reality-compatible device, a graphical representation of a user, e.g., an avatar, or an object, in an extended-reality (ER) environment.

Block 604 represents initiating recording of the graphical representation according to a schema.

Block 606 represents producing, e.g., via the extended-reality-compatible device, a copy of the recording of the graphical representation of the user as a new graphical representation of the user in the ER environment.

Block 608 represents controlling the new graphical representation of the user at a first location in the extended-reality environment. In some examples, the first location can include a location beyond-arm's-length distance from a second location in the extended-reality environment. The second location can include a location of a representation of a user, e.g., an avatar of a user, and/or a representation of a control associated with the user of the extended-reality-compatible device, e.g., an I/O interface, e.g., a wearable device, such as a head-mounted display (e.g., headset, glasses, helmet, visor, etc.), a suit, gloves, a watch, or any combination of these, a handheld computing device (e.g., tablet, phone, handheld gaming device, etc.), a portable computing device (e.g., laptop), or a stationary computing device (e.g., desktop computer, television, set top box, a vehicle computing device).

Although the discussion above sets forth examples of the described techniques and technology, other architectures can be used to implement the described functionality and are intended to be within the scope of this disclosure. Furthermore, although the subject matter has been described in language specific to structural features and/or methodological acts, it is to be understood that the subject matter defined in associated claims is not necessarily limited to the specific features or acts described. Rather, the specific features and acts are disclosed as example forms of implementing the claims.

### EXAMPLE CLAUSES

Clause 1: A method comprising: generating, via an extended-reality-compatible device, a graphical representation of a user in an extended-reality (ER) environment; initiating, via the extended-reality-compatible device, a recording of the graphical representation of the user according to a schema; producing, via the extended-reality-compatible device, a copy of the recording of the graphical representation of the user as a new graphical representation of the user in the ER environment; and controlling the graphical representation of the user at a first location in the extended-reality environment.

Clause 2: A method as clause 1 recites, wherein the new graphical representation of the user performs motion and/or produces sound from the recording in a loop.

Clause 3: A method as clause 1 or 2 recites, wherein the controlling the graphical representation of the user includes moving the graphical representation of the user around the ER environment while the new graphical representation of the user performs motion and/or produces sound from the recording in a loop.

Clause 4: A method as any of the previous clauses recite, wherein the new graphical representation of the user and the graphical representation of the user interact.

Clause 5: A method as any of the previous clauses recite, wherein the new graphical representation of the user is a first new graphical representation of the user, the method further comprising the first new graphical representation of the user interacting with an input device associated with the graphical representation of the user to produce another, second, new graphical representation of the user.

Clause 6: A method as any of the previous clauses recite, wherein the first new graphical representation of the user and a second new graphical representation of the user interact with each other.

Clause 7: A method as any of the previous clauses recite, wherein the graphical representation of the user provides a view of the first new graphical representation of the user and a second new graphical representation of the user interacting with each other from the perspective of the graphical representation of the user.

Clause 8: A method as any of the previous clauses recite, wherein input to initiate recording to produce a new graphical representation of the user includes one or more of: manipulation of a button or another object, virtual manipulation of a graphical representation of an object corresponding to the button or other object, a voice input, a gesture input, a gaze input.

Clause 9: A method as any of the previous clauses recite, wherein the producing includes recording at an ad-hoc location.

Clause 10: A method as any of the previous clauses recite, the method further comprising moving the new graphical representation of the user to a desired location.

Clause 11: A method as any of the previous clauses recite, the method further comprising moving the graphical representation of the user to a desired location before presenting the new graphical representation of the user.

Clause 12 A method as any of the previous clauses recite, wherein input to initiate recording to produce a new graphical representation of the user includes placement of the graphical representation of the user in a pre-designated location.

Clause 13: A method as any of the previous clauses recite, further comprising controlling the graphical representation of the user or new graphical representation of the user to interact with an item in the ER environment.

Clause 14: A method as clause 13 recites, wherein the interaction includes at least one of the graphical representation of the user or new graphical representation of the user picking up the item and/or moving the item.

Clause 15: A method as clause 13 or 14 recites, wherein the interaction includes: the graphical representation of the user taking the item and/or receiving the item from the new graphical representation of the user, the new graphical representation of the user taking the item and/or receiving the item from the graphical representation of the user or another new graphical representation of the user.

Clause 16: A method as any of the previous clauses recite, further comprising sending a copy of a recording of the new graphical representation of the user in the ER environment as an asynchronous communication.

Clause 17: A computer-readable medium having processor-executable instructions thereon, which, upon execution configure the extended-reality-compatible device to perform a method as any of the previous clauses recite.

Clause 18: An extended-reality system comprising: a processor; and a computer-readable medium as clause 17 recites.

Clause 19: The extended-reality-compatible device of clause 1 comprising: a processor; and a computer-readable medium having processor-executable instructions thereon, which, upon execution by the processor, configure the extended-reality-compatible device to perform a method as any of clauses 1-16 recite.

We claim:

1. A method comprising:
generating, via an extended-reality-compatible device, a graphical representation of a user in an extended-reality (ER) environment;
initiating, via the extended-reality-compatible device, a recording of the graphical representation of the user according to a schema;
producing, via the extended-reality-compatible device, a copy of the recording of the graphical representation of the user as a new graphical representation of the user in the ER environment; and
controlling the graphical representation of the user at a first location in the extended-reality environment.

2. A method as claim 1 recites, wherein the controlling the graphical representation of the user includes moving the graphical representation of the user around the ER environment while the new graphical representation of the user performs motion and/or produces sound from the recording in a loop.

3. A method as claim 1 recites, wherein the new graphical representation of the user performs motion and/or produces sound from the recording in a loop.

4. A method as claim 3 recites, wherein the controlling the graphical representation of the user includes moving the graphical representation of the user around the ER environment while the new graphical representation of the user performs a motion and/or produces a sound from the recording in a loop.

5. A method as claim 1 recites, wherein the new graphical representation of the user and the graphical representation of the user are configured to interact.

6. A method as claim 1 recites, wherein the new graphical representation of the user is a first new graphical representation of the user, the method further comprising the first new graphical representation of the user interacting with an input device associated with the graphical representation of the user to produce a second new graphical representation of the user.

7. A method as claim 6 recites, wherein the first new graphical representation of the user and a second new graphical representation of the user interact with each other.

8. A method as claim 6 recites, wherein the graphical representation of the user provides a view of the first new graphical representation of the user and a second new graphical representation of the user interacting with each other from a perspective of the graphical representation of the user.

9. A method as claim 1 recites, wherein input to initiate recording to produce a new graphical representation of the user includes one or more of: manipulation of a button or another object, a voice input, a gesture input, or a gaze input.

10. A method as claim 1 recites, wherein input to initiate recording to produce a new graphical representation of the user includes virtual manipulation of a graphical representation of an object corresponding to a button or other object.

11. A method as claim 1 recites, wherein the producing includes recording at an ad-hoc location.

12. A method as claim 1 recites, the method further comprising moving the new graphical representation of the user to a new location.

13. A method as claim 1 recites, the method further comprising moving the graphical representation of the user to a new location before presenting the new graphical representation of the user.

14. A method as claim 1 recites, wherein input to initiate recording to produce a new graphical representation of the user includes placement of the graphical representation of the user in a pre-designated location.

15. A method as claim 1 recites, further comprising controlling the graphical representation of the user or new graphical representation of the user to interact with an item in the ER environment.

16. A method as claim 15 recites, wherein the interaction includes at least one of the graphical representation of the user or new graphical representation of the user picking up the item and/or moving the item.

17. A method as claim 15, wherein the interaction includes: the graphical representation of the user taking the item and/or receiving the item from the new graphical representation of the user, the new graphical representation of the user taking the item and/or receiving the item from the graphical representation of the user or another new graphical representation of the user.

18. A method as claim 1 recites, further comprising sending a copy of a recording of the new graphical representation of the user in the ER environment as an asynchronous communication.

19. A computer-readable medium having processor-executable instructions thereon, which, upon execution configure an extended-reality-compatible device to perform operations comprising:
generating, via an extended-reality-compatible device, a graphical representation of a user in an extended-reality (ER) environment;
initiating, via the extended-reality-compatible device, a recording of the graphical representation of the user according to a schema;
producing, via the extended-reality-compatible device, a copy of the recording of the graphical representation of the user as a new graphical representation of the user in the ER environment; and
controlling the graphical representation of the user at a first location in the extended-reality environment.

20. An extended-reality device comprising:
a processor; and
a computer-readable medium coupled to the processor and having processor-executable instructions thereon, which, upon execution, configure an extended-reality-compatible device to:
generate, via an extended-reality-compatible device, a graphical representation of a user in an extended-reality (ER) environment;
initiate, via the extended-reality-compatible device, a recording of the graphical representation of the user according to a schema;
produce, via the extended-reality-compatible device, a copy of the recording of the graphical representation of the user as a new graphical representation of the user in the ER environment; and
control the graphical representation of the user at a first location in the extended-reality environment.
